(19) United States
(12) Patent Application Publication
(10) Pub. No.: US 2024/0261810 A1
(43) Pub. Date: Aug. 8, 2024

(54) SPRAY GUN APPLICATOR

(71) Applicant: CARLISLE CONSTRUCTION MATERIALS, LLC, Carlisle, PA (US)

(72) Inventors: Eric DONALDSON, Oakdale, MN (US); Phil BOLEA, Oakdale, MN (US); Bruce NELSON, Oakdale, MN (US); Tom REEDER, Oakdale, MN (US); Forrest WILDE, Oakdale, MN (US); Brian CALAMAN, Carlisle, PA (US); Austin KULP, Carlisle, PA (US)

(73) Assignee: CARLISLE CONSTRUCTION MATERIALS, LLC, Carlisle, PA (US)

(21) Appl. No.: 18/624,630

(22) Filed: Apr. 2, 2024

Related U.S. Application Data
(63) Continuation-in-part of application No. 18/576,682, filed on Jan. 1, 0001.
(60) Provisional application No. 63/219,174, filed on Jul. 7, 2021.

(51) Int. Cl. B05B 12/00; B05B 12/08

(52) U.S. Cl. CPC B05B 12/002; B05B 12/08

(57) ABSTRACT

A plural component applicator including a nozzle attached to a gun body, wherein the gun body comprises a manifold configured to receive a plurality of components based on operation of a trigger assembly, wherein the manifold is configured to separately deliver the plurality of components to a static mixer within the nozzle based on operation of the trigger assembly.

### RELATED APPLICATION

The present application is a Continuation-In-Part (CIP) of and claims priority to U.S. patent application Ser. No. 18/576,682, entitled “Applicator”, filed Jan. 4, 2024, which is a U.S. National Phase application of International Patent Application No. PCT/US2022/036236, entitled “Applicator”, filed Jul. 6, 2022, and to U.S. Provisional Patent Application Ser. No. 63/219,174, entitled “Applicator”, filed Jul. 7, 2021, the entire disclosures of which are incorporated herein by reference in their entireties, for all purposes.

### TECHNICAL FIELD

The present system relates in general to Applicator Spray Guns, and in particular to Applicator Spray Guns used for spraying two component sprays such as spray-on insulation foams and adhesives.

### BACKGROUND OF THE INVENTION

Spray-on building insulation foams and adhesives are typically applied onto a roof using a spray gun (also known as an “applicator”). In the applicator two separate fluid streams meet and mix before they're sprayed onto the roof. Common problems with these conventional spray guns are that they often don't produce a consistent bead spacing or splatter coverage on the roof. As a result, some foam or adhesive is always wasted and more foam or adhesive is sprayed onto the roof than would be desirable.

It would instead be desirable to build systems that provide an even, predictable and uniform distribution of the spray foam or adhesive onto the roof. Such a system would increase efficiencies and permit faster installation with increased final quality. In addition, it would also be desirable to provide a spray foam or adhesive application onto a plurality of parallel locations simultaneously since spray foams and adhesives are typically applied in parallel lines along the roof. In addition, wind across the surface of the roof can cause problems with spray foam application. It would instead be desirable to dispense the spray foam or adhesive much closer to the roof's surface than is currently being done in the industry. This would allow for less material loss and a cleaner and more consistent application, thereby resulting in improved spray quality. It would also be desirable to gather time and motion information from one spray gun application that could be used with other spray gun applications in future. Recording such information (preferably including spraying times and corresponding spray gun movements) could be used to improve spray quality and aid in system troubleshooting.

As will be explained herein, the present system addresses these above concerns and provides solutions to remedy these problems.

### SUMMARY OF THE INVENTION

In preferred aspects, the present system relates to a plural component spray gun applicator that can include a nozzle attached to a gun body. The gun body preferably comprises a manifold configured to receive a plurality of components based on operation of a trigger assembly, and the manifold is also configured to separately deliver the plurality of components to a static mixer located within the nozzle based on operation of the trigger assembly.

In other preferred aspects, the present system provides a spray applicator, comprising: (a) a fluid manifold having a first fluid chamber and a second fluid chamber; (b) a first valve permitting fluid flow into the first fluid chamber; (c) a second valve permitting fluid flow into the second fluid chamber, wherein both the first and second valves are received into the fluid manifold; (d) a handle assembly; (e) a nozzle attached to the handle assembly, wherein fluid flows out of the first and second fluid chambers and into the nozzle; and (f) a trigger assembly, wherein movement of the trigger assembly opens and closes the first and second valves; and wherein the handle assembly and trigger assembly are connected together around the manifold.

In preferred aspects, the manifold is snap-fit together and the manifold is in turn snap fit into the handle assembly and into the trigger assembly. The manifold is specifically configured to burst in an overpressure situation. The manifold is pressurized by fluid flow therethrough, but the handle and trigger assemblies are not pressurized by fluid flow therethrough. The advantage of this design approach is that the manifold can be designed and built to higher precision, whereas the handles and trigger assemblies can be manufactured with more relaxed tolerances, such that they can be built more cheaply. As such, only the manifold itself (which is a small component of the system in terms of material requirements) has to be built to precision high tolerances.

In preferred aspects, the present system also includes an accelerometer to detect movement of the spray applicator and an internal control unit. The internal control unit can be configured to power down the spray applicator after a predetermined passage of time with no detected movement, and/or it can log movement data of the spray applicator over time which can be downloaded for future use.

In other preferred aspects, a third fluid chamber can be added to the manifold such that air can be introduced into the mixture that is sprayed out of the applicator.

In yet other preferred aspects, the nozzle is connected to an elongated spray tube such that the operator can apply spray at a distance closer to the roof as (s)he walks across the roof. Optionally, this spray tube may be forked to terminate in dual streams. In addition, the spray tube may also terminate with a fan-shaped outlet to give a more desired spray pattern (or two fan-shaped outlets in the case of a dual stream embodiment).

### BRIEF DESCRIPTION OF THE DRAWINGS

FIG. 1 is a view of the embodiments described herein.

FIG. 2 is a side cutaway view of the embodiments described herein.

FIG. 3 is an exploded view of the embodiments described herein.

FIG. 4 is a top cutaway view of the embodiments described herein.

FIG. 5 is a top view of the embodiments described herein.

FIG. 6 is a view of a portion of the embodiments described herein.

FIG. 7 is a view of a portion of the embodiments described herein.

FIG. 8 is a view of a portion of the embodiments described herein.

FIG. 9 is a view of a portion of the embodiments described herein.

FIG. 10 is an exploded perspective view of an embodiment of the present invention.

FIG. 11A is a simplified perspective view of a three fluid component manifold.

FIG. 11B is a side elevation view corresponding to FIG. 11A.

FIG. 12A is a perspective view of an elongated spray tube on the nozzle of the applicator.

FIG. 12B is a perspective view of an elongated spray tube terminating in dual streams.

FIG. 13 is a perspective view of a fan-shaped outlet at the end of the spray tube.

FIG. 14A is an illustration of a spool valve suitable for use in the present manifold in place of a needle valve, showing the valve in a closed position.

FIG. 14B is the valve of FIG. 14A, but now moved to an open position.

FIG. 14C is similar to FIGS. 14A and 14B, but further adds air passing into an air chamber.

### DETAILED DESCRIPTION OF THE DRAWINGS

In the following description, reference is made to the accompanying drawings which form a part hereof and which illustrate several embodiments of the present invention. It is understood that other embodiments may be utilized and structural and operational changes may be made without departing from the scope of the present invention.

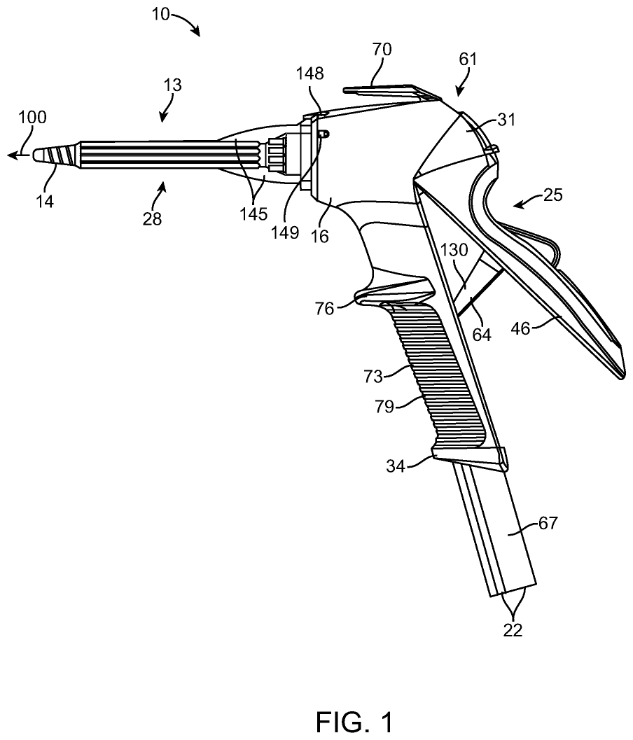

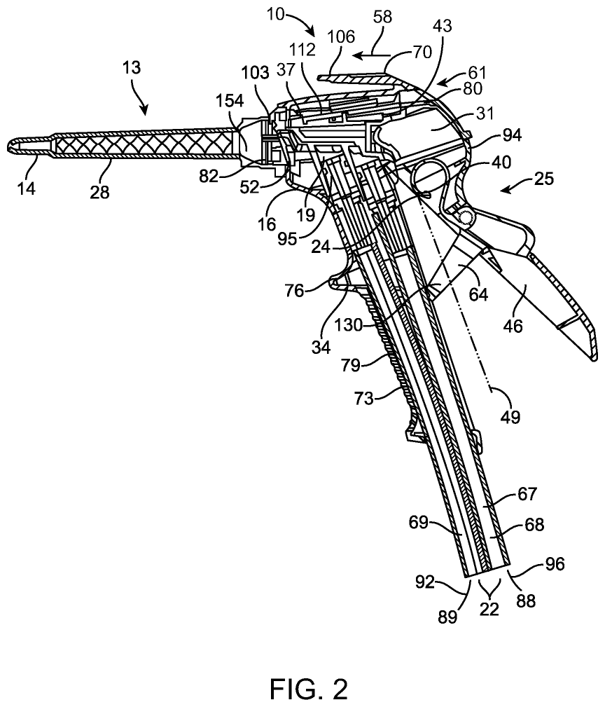

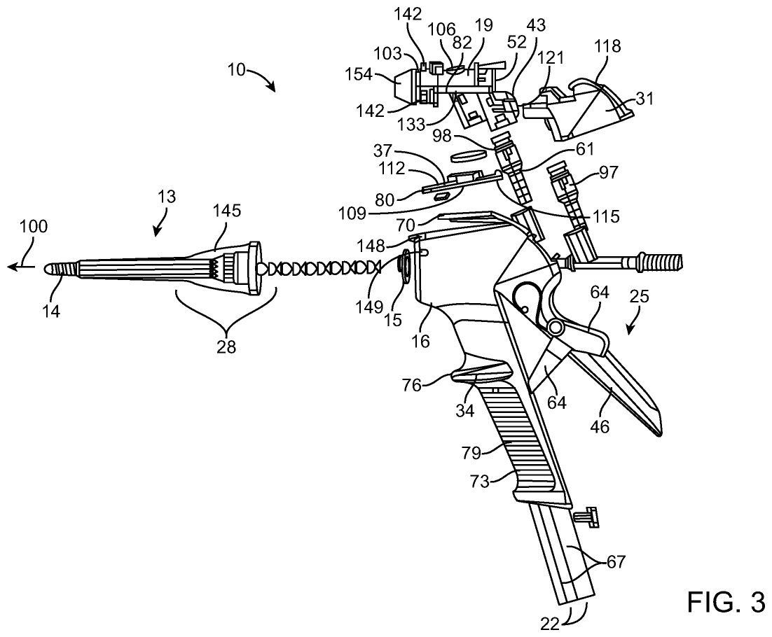

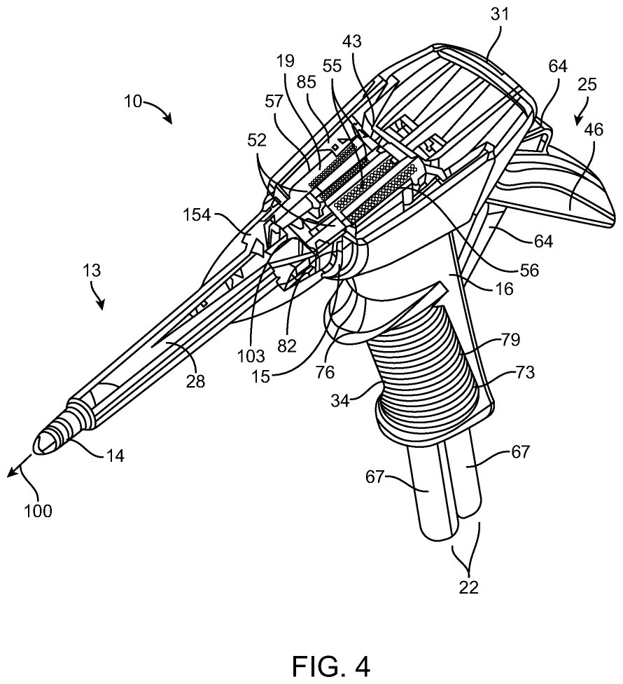

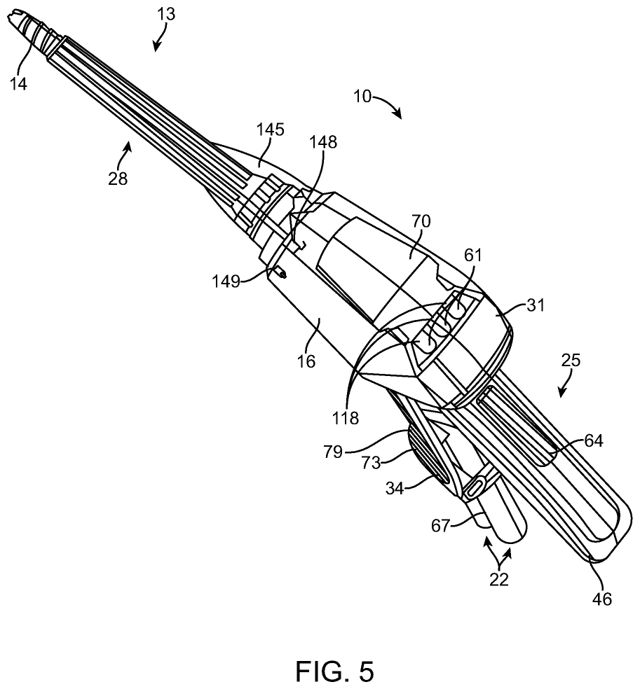

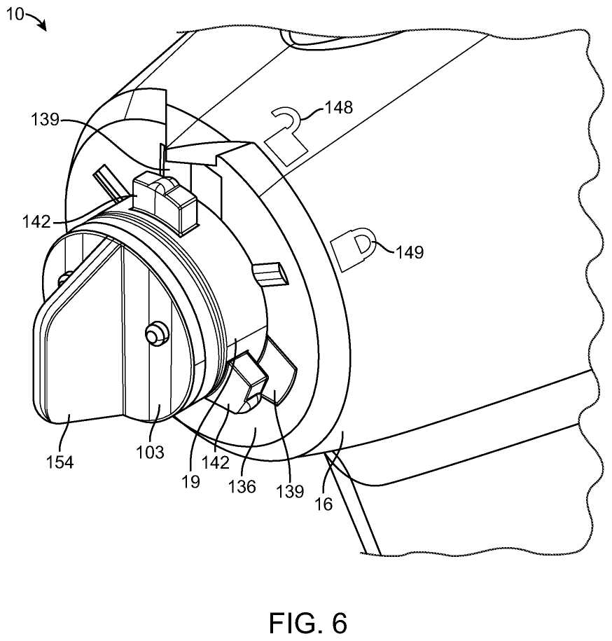

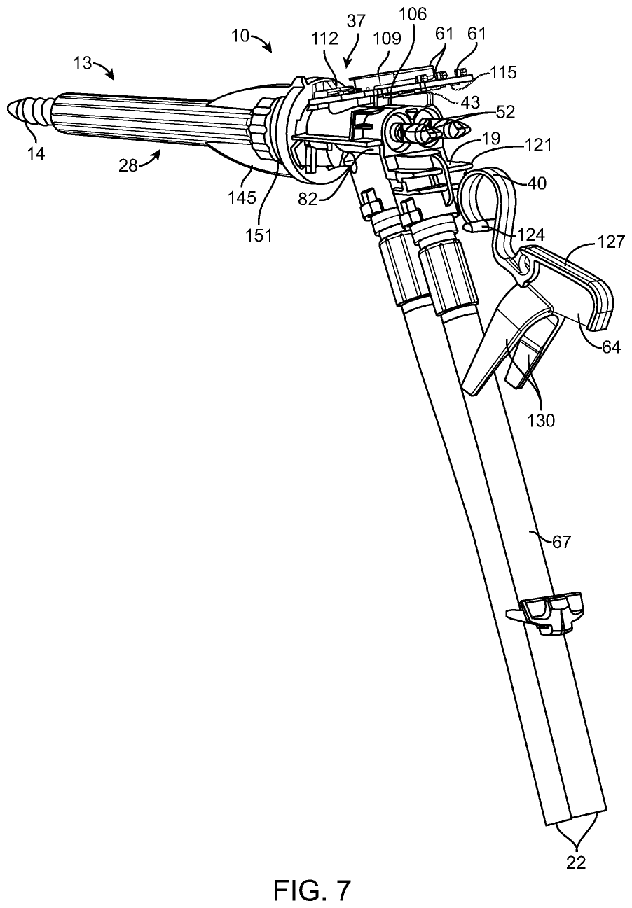

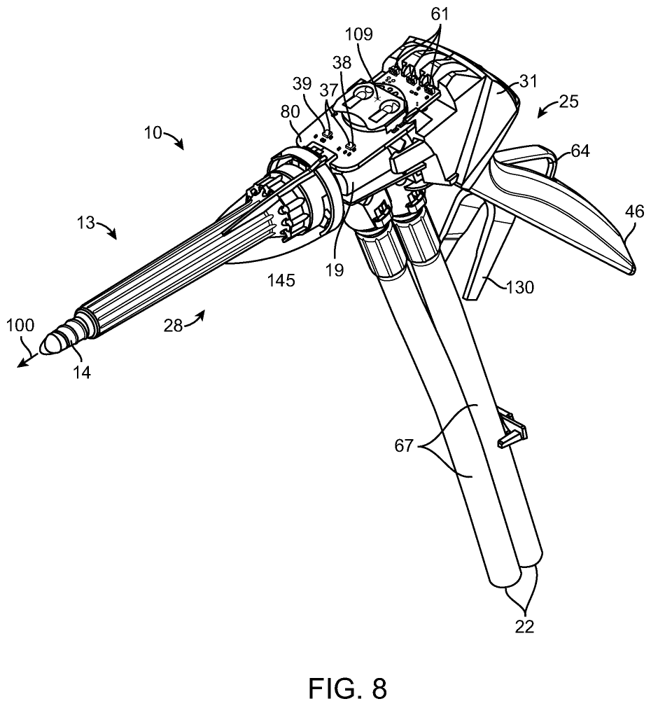

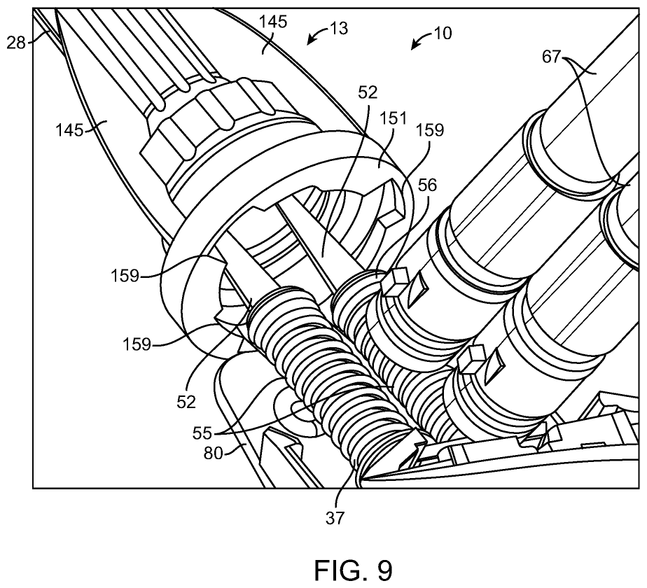

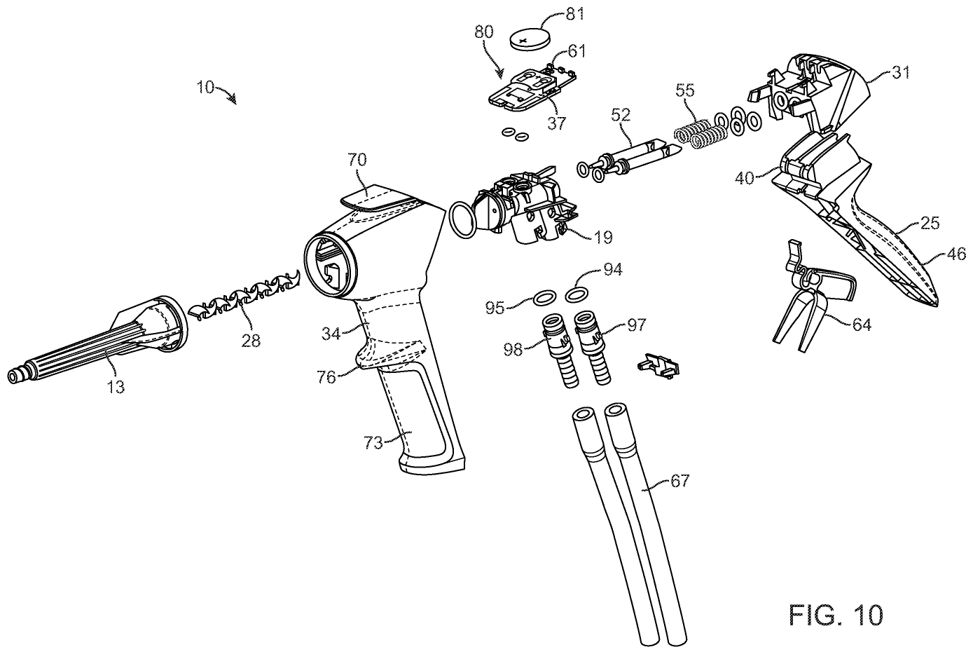

As shown in FIGS. 1-10, a plural component applicator 10 can include a nozzle 13 attached to a gun body 16, wherein the gun body 16 comprises a manifold 19 configured to receive a plurality of components 22 based on operation of a trigger assembly 25, wherein the manifold 19 is configured to separately deliver the plurality of components 22 to a static mixer 28 within the nozzle 13 based on operation of the trigger assembly 25.

In some embodiments, the plural component applicator 10 can provide that the gun body 16 comprises a rear hood 31 and handle 34. In certain embodiments, the plural component applicator 10 can further provide that the manifold 19 is configured to snap fit into the handle 34 and rear hood 31. In some embodiments, the plural component applicator 10 can provide that the rear hood 31 is configured to snap fit into the handle 34 as well.

In certain embodiments, the plural component applicator 10 can further include at least one temperature sensor 37 for sensing the temperature or the fluid(s) or for sensing ambient air temperature, or both.

In certain embodiments, the plural component applicator 10 can further provide that the trigger assembly 25 comprises a cam 40 configured to rotate against a rear external surface 43 of the manifold 19. The cam face rotates against a bearing surface in a manner that moves the fulcrum to increase trigger lever moment as the trigger assembly 25 is actuated. This counteracts the increasing force of the needle valve springs as they are compressed, resulting on trigger forces that are more constant than would be encountered by a fixed trigger point.

Preferably, a position indicator that is integral to the trigger will tell the operator how far to pull the trigger based upon the level of fluid in the pressurized tanks. This prevents premature exhaustion of propellant from the tanks. In some embodiments, the plural component applicator 10 can provide that the trigger assembly 25 comprises a trigger 46 configured to increase a lever moment 49 based on actuation of the trigger 46. According to some embodiments, the plural component applicator 10 can include a trigger lock mechanism 64 configured to prevent accidental actuation and dispensing. Specifically, trigger lock mechanism 64 may auto-engage such that the user is required to grasp fully around the handle to unlock the device. In some embodiments, the plural component applicator 10 can provide that the applicator comprises an integral hook 70. According to some embodiments, the plural component applicator 10 can include a hand grip 73, a finger shelf 76, and surface texturing 79.

In certain embodiments, the plural component applicator 10 can further include a plurality of needle valves 52 and springs 55, wherein the lever moment 49 is configured to counteract an increasing force of the springs 58 based on actuation of the trigger 46 to thereby operate the needle valves 52.

According to some embodiments, the plural component applicator 10 can include at least one optical indicator 61, wherein the at least one optical indicator 61 is configured to optically transmit information related to battery power, trigger 46 actuation, fluid temperature conditions of both components, pressure conditions of both components, or combinations thereof. In preferred embodiments, temperature sensor 37 can be used to determine if fluid temperatures are within specified environmental ranges. This is important as spray application can typically not be carried out at excessively high or excessively low temperature ranges.

According to certain embodiments, the plural component applicator 10 can include a plurality of hoses 67, wherein the hoses 67 are configured to enter the manifold 19 through the handle 34. In some embodiments, the plural component applicator 10 can provide that the manifold 19 is configured to sacrificially and deterministically burst based on a material overpressure situation as described further below. In one embodiment, the manifold wall thickness is designed to fail at predetermined pressures. Preferably as well, the manifold fails in a manner that the fluid escapes forwards out of the nozzle, or out the rear of the manifold 19.

For example, in certain embodiments, the plural component applicator 10 can provide that the manifold 19 comprises an internal pressure, and wherein the manifold 19 is configured to sacrificially and deterministically burst if an internal pressure of the manifold 19 reaches a pressure of 200 to 220 pounds per square inch or up to 300 pounds per square inch. In certain embodiments, the plural component applicator 10 can provide that the manifold 19 comprises a dividing wall 154 on a forward external surface 103 of the manifold 19 configured to segregate the first fluid 91 from the second fluid before contact with a static agitator of the static mixer 28. In some embodiments, the plural component applicator 10 can include an o-ring seal 15 attached to the forward external surface 103 of the manifold 19.

In preferred aspects, the manifold 19 is snap-fit together, and the handle assembly 34 and trigger assembly 25 are connected together around the manifold. Preferably, the handle and trigger assemblies 25 and 35 are snap-fit together around manifold. Only the manifold 19 is actually pressurized by fluid flow therethrough, whereas the handle assembly 25 and trigger assembly 35 are not pressurized by fluid flow therethrough. As a result, the manifold can be designed and built to higher precision, whereas the handles and trigger assemblies 35 and 25 can be manufactured with more relaxed tolerances, such that they can be built more cheaply. As such, only the manifold itself (which is a small component of the overall system in terms of material requirements) has to be built to precision high tolerances.

The plural component applicator 10 can include a first fluid chamber 82 configured to receive a first fluid 91 from a first fluid source 88 through a first fluid hose 68 based on operation of a trigger 46; a second fluid chamber 85 configured to receive a second fluid from a second fluid source 89 through a second fluid hose 69 based on operation of the trigger 46; a static mixer 28 configured to receive the first fluid 91 from the first fluid 91 chamber 82 and second fluid 92 from the second fluid chamber 85 and form a third fluid 100, wherein the third fluid 100 is a mixture of the first and second fluid, a reaction product of the first and second fluid, or a combination thereof; and a nozzle tip 14 configured to output the third fluid 100. In some embodiments, the plural component applicator 10 can include a nozzle 13, wherein the nozzle 13 consists of a single piece nozzle 13 body comprising the nozzle tip 14 and the static mixer 28. In some embodiments, the plural component applicator 10 can include a manifold 19, wherein the manifold 19 comprises the first fluid 91 chamber 82 and second fluid chamber 85. In further optional embodiments, additional chambers with additional fluids and gasses can also be added.

According to some embodiments, the plural component applicator 10 can include an internal control unit 80 housed within the gun body 16 configured to reduce a battery drain (from battery 81) when the applicator is not in use and to store performance information. In other embodiments, internal control unit 80 further comprises an accelerometer configured to detect movement of the spray applicator. Preferably, internal control unit 80 is configured to power down the spray applicator after a predetermined passage of time with no detected movement. Preferably as well, the internal control unit logs movement data of the spray applicator over time and such movement data can be downloaded from the internal control unit (for example for quality control and training purposes). Other data may also optionally be logged, including product temperature data, pressure data, or other data as well. In addition, such other data may be read by an external LED reader.

In some embodiments, the plural component applicator 10 can include an internal control unit 80 and a gun body 16, wherein the internal control unit 80 is removably attached to a top external surface 106 of the manifold 19 and within the gun body 16. In certain embodiments, the plural component applicator 10 can provide that the internal control unit 80 comprises a first sensor 38 and a second sensor 39. According to certain embodiments, the plural component applicator 10 can provide that the first sensor 38 is a temperature sensor 37, pressure sensor, or combination thereof. In certain embodiments, the plural component applicator 10 can provide that the second sensor 39 is a temperature sensor 37, pressure sensor, or combination thereof, wherein the first sensor 38 is configured to detect a first condition of the first fluid chamber 82, and the second sensor 39 is configured to detect a second condition of the second fluid chamber 85. In certain embodiments, the plural component applicator 10 can provide that the internal control unit 80 is a printed circuit assembly, wherein the printed circuit assembly comprises a button battery space 109. According to certain embodiments, the plural component applicator 10 can provide that the internal control unit 80 comprises memory, wherein the memory is configured to store data received from the first sensor 38 and second sensor 39. According to certain embodiments, the plural component applicator 10 can provide that the internal control unit 80 comprises I/O port 109, wherein the I/O port 109 is configured to interface with an external computer system to output data from the memory to the computer system. According to certain embodiments, the plural component applicator 10 can provide that the internal control unit 80 comprises an accelerometer 115. In certain embodiments, the plural component applicator 10 can provide that the accelerometer 115 is configured to power down the plural component applicator 10 based on a predetermined passage of time with no detected movement. According to certain embodiments, the plural component applicator 10 can provide that the accelerometer 115 is configured to store changes in motion in the memory. According to certain embodiments, the plural component applicator 10 can provide that the internal control unit 80 further comprises a plurality of optical indicators 61. In some embodiments, the plural component applicator 10 can include comprising a rear hood 31, wherein the rear hood 31 comprises grooves 118 for each of the plurality of optical indicators 61.

The plural component applicator 10 can include a gun body 16; a nozzle 13; a handle 34; a first hose configured to deliver a first fluid to a first chamber in a manifold 19 based on actuation of a trigger assembly 25; and a second hose configured to deliver a second fluid to a second chamber in a manifold 19 based on actuation of the trigger assembly 25; wherein actuation of the trigger assembly 25 is configured to rotate a cam 40 against a rear external surface 43 of the manifold 19, thereby acting with a force against that of a first needle valve spring 56 and a second needle valve spring 57.

In certain embodiments, the plural component applicator 10 can provide that the rear external surface 43 of the manifold 19 comprises a notch portion 121, wherein the cam 40 comprises a perpendicular end portion 124, wherein the perpendicular end portion 124 is configured to fit within the notch portion 121 based on the trigger 46 being fully actuated against the handle 34. In certain embodiments, the plural component applicator 10 can provide that the cam 40 is directly connected to a trigger lock mechanism 64. According to some embodiments, the plural component applicator 10 can provide that the cam 40 and trigger lock mechanism 64 form an integral piece 127. In some embodiments, the plural component applicator 10 can provide that the trigger lock mechanism 64 comprises a fork portion 130 configured to slide within the handle 34 based on actuation of the trigger lock mechanism 64. According to some embodiments, the plural component applicator 10 can provide that the trigger assembly 25 comprises a trigger 46, wherein actuation of the trigger 46 is prevented by the trigger lock mechanism 64 when the trigger lock mechanism 64 is not actuated, and wherein actuation of the trigger 46 is enabled by actuation of the trigger lock mechanism 64. In certain embodiments, the plural component applicator 10 can provide that rotation of the cam 40 against the external surface of the manifold 19 increases a trigger 46 moment directly with increasing opposite force from the first and second needle valve springs 55.

According to some embodiments, the plural component applicator 10 can provide that the first hose is circumscribed by the handle 34 and connects to a manifold 19 bottom surface through a first hose fitting 97 and first hose o-ring 94, wherein the second hose connects to the manifold 19 bottom surface through a second hose fitting 98 and second hose o-ring 95. Preferably, a twist-fit connection is used to secure the hoses to the manifold.

In certain embodiments, the plural component applicator 10 can provide that the gun body 16 comprises a front face with a plurality of gun body front face notches 139, wherein the manifold 19 comprises a corresponding set of protrusions 142 configured to fit through the gun body front face notches 139. In some embodiments, the plural component applicator 10 can provide that the nozzle 13 comprises at least one alignment guide 145 and the gun body 16 comprises a visual indicator of an unlocked position 149 of the nozzle 13 relative to the gun body 16, wherein the alignment guide 145 can be attached and removed from the gun body 16 when the alignment guide 145 is aligned with the visual indicator of the unlocked position 148. In certain embodiments, the plural component applicator 10 can provide that the gun body 16 comprises a visual indicator of a locked position 149 of the nozzle 13 relative to the gun body 16, wherein the alignment guide 145 can be moved from the unlocked position 149 to the locked position 149 to attach the gun body 16. In some embodiments, the plural component applicator 10 can provide that the nozzle 13 comprises a nozzle back face 151 comprising nozzle notches 159 corresponding to the set of protrusions 142, wherein when the nozzle 13 guide is in the unlocked position 149, the nozzle notches 159 align with the protrusions 142, wherein movement of the nozzle 13 guide from the unlocked to the locked position 149 moves the nozzle notches 159 away from the protrusions 142 and locks the nozzle 13 to the gun body 16 by placing the nozzle back face 151 between the protrusions 142 and the gun body front face 136.

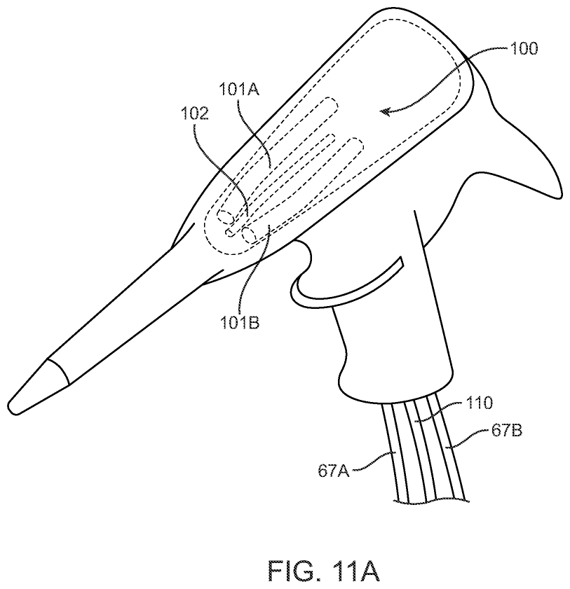

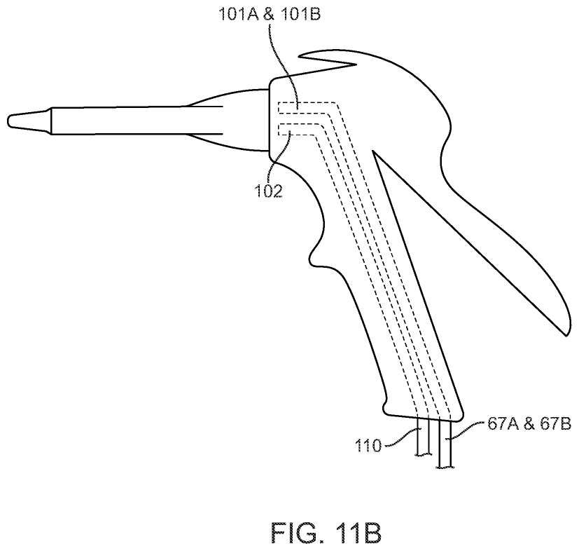

FIGS. 11A and 11B are simplified perspective and elevation views of a three fluid component manifold 100. In this embodiment, the same trigger assembly described above can be used to now simultaneously open flow into three separate internal chambers 101A and 101B and 102. As illustrated, chamber 101A is connected to liquid hose 67A, chamber 101B is connected to liquid hose 67B and chamber 102 is connected to air hose 110. This operation is similar to how needle valves 52 opened to allow fluid into the first and second fluid chambers described above in the embodiment of FIGS. 1 to 10. In preferred embodiments, a third valve is now included to open the third chamber 102. This valve may been a needle valve as described above, a spool valve, or any other suitable type of valve. In this three component embodiment of the manifold, air can be entering the third chamber through air hose 110, and each of the two components of the spray-on insulation or adhesive can enter manifold 100 through fluid hoses 67A and 67B. The advantage of this three component spray is that the addition of air may be used to increase bubbling or splattering of the spray-on application. It is to be understood that chambers 101A, 101B and 102 are illustrated conceptually in FIGS. 11A and 11B and that the sizes and placements of the chambers may be varied. In addition, the chamber 102 may meet chambers 101A and 101B at any location within the spray gun, including at the end of the manifold itself. The size of the third chamber 102 may also be adjustable and its size may be set to best correspond to the particular chemical components that are passing through the adapter spray gun. The addition of air into the sprayed mixture leaving the gun is that it will create more of a splatter thereby increasing material coverage area.

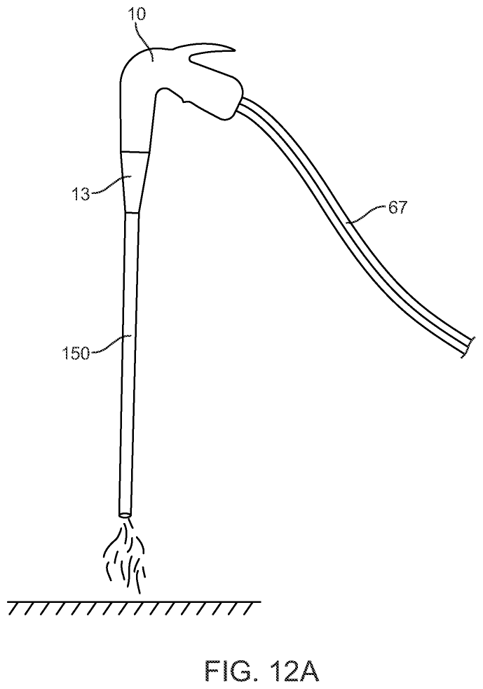

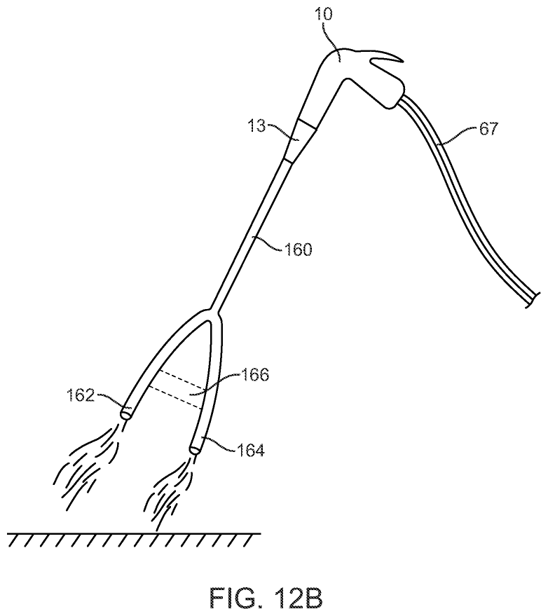

FIG. 12A is a perspective view of an elongated spray tube 150 attached onto the nozzle 13 of the applicator 10. This spray tube 150 is preferably made from a semi-rigid piece of plastic tubing. The advantage of spray tube 150 is that it better defines the pattern of material dispensed. As such, an operator can dispense material along well defined lines. Another advantage of spray tube 150 is that the mixed spray exits applicator 10 at a location much closer to the roof surface. This permits the operator to walk upright without having to bend over during the spraying. Also, directing the spray from a location closer to the roof itself prevents accidental splatter in unwanted locations. This is especially beneficial when working in the wind on top of a building.

FIG. 12B is a perspective view of an elongated spray tube 160 terminating in dual streams at its ends 162 and 164. Spray tube 160 operates similar to spray tube 150 described above, however, the dual ends permits the operator to walk over the roof surface applying spray in two parallel lines. This saves considerable time. An optional spacer 166 can be used to hold ends 162 and 164 a preferred distance apart. This is beneficial because spray lines are preferred distances apart (with the spacing being dependent upon the particular components being sprayed). In optional preferred embodiments, spacer 166 is adjustable such that the preferred spacing between ends 162 and 164 can be set at the start of the job. In various embodiments, the spray tubes 160, 162 and 164 can have different or similar lengths, all depending upon user preference. The dual streams highly improves consistency of bead spacing and helps improve the quality of the installation. Tube 160 may be a disposable or non-disposable component, as desired.

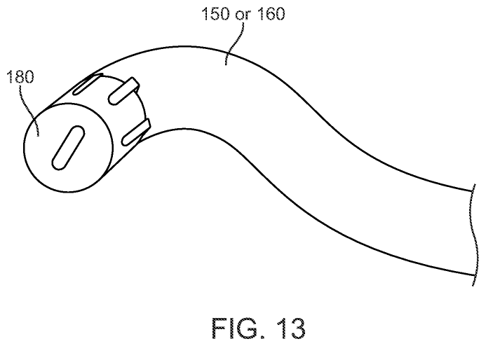

FIG. 13 is a perspective view of a fan-shaped outlet 180 at the end of spray tube 150 or 160. The advantage of fan-shaped outlet 180 is that by moving fan tip outlet 180 closer to the applied surface reduces the material waste due to environmental conditions. In addition, it provides a more ergonomic application method so the individual applying the material does not need to bend over to move the applicator closer to the surface on which the material is applied.

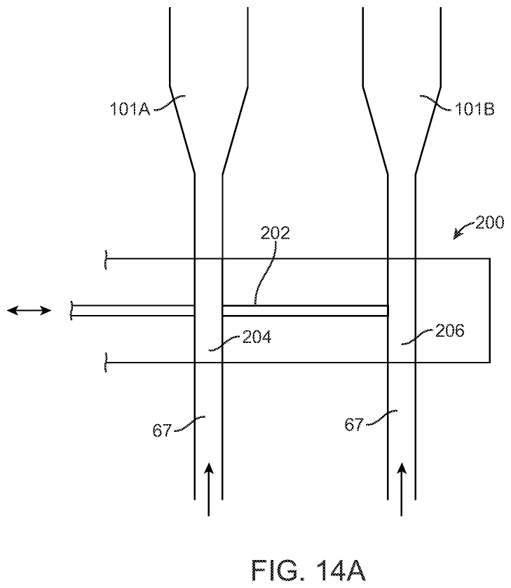

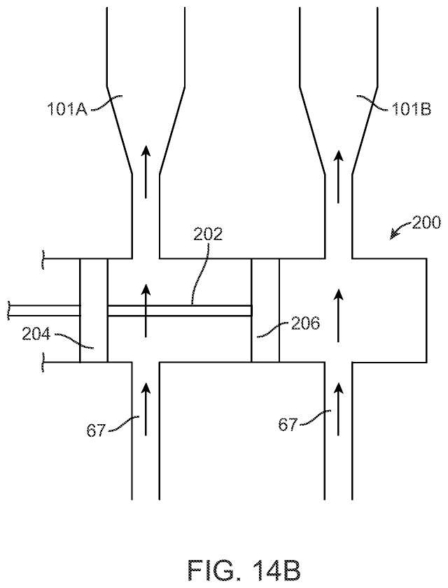

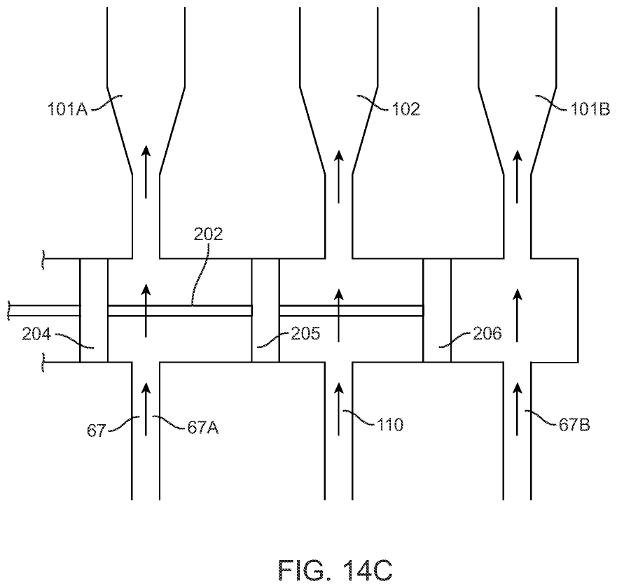

FIGS. 14A and 14B schematically illustrate a spool valve 200 suitable for use in the present manifold in place of the needle valves 52. Spool valve 200 has a laterally moveable plunder 202 and a pair of disks 204 and 206. Plunger 202 is preferably moved electrically, pneumatically or manually. When the plunger 202 holds disks 204 and 206 as shown in FIG. 14A, the flow is closed. FIG. 14B shows plunger 202 moved to the left such that disks 202 and 204 no longer block the flow paths, such that the fluid components passing through hoses 67 are directed into the first and second fluid chambers 101A and 101B in the applicator (such that they will mix in the applicator and are then directed out of the nozzle 13 of the spray gun applicator). Lastly, FIG. 14C corresponds to the three chamber embodiment of the present system, showing air passing into the air chamber. As can be seen, plunger 202 now opens all three chambers 101A, 101B and 102 by moving disks 204, 206 and 205. It is to be understood that the spool valve of FIGS. 14A, 14B and 14C is only exemplary and that other embodiments of spool valves (and other valves) are all encompassed by the present invention.

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A spray applicator, comprising:
a fluid manifold having a first fluid chamber and a second fluid chamber;
a first valve permitting fluid flow into the first fluid chamber;
a second valve permitting fluid flow into the second fluid chamber;
wherein both the first and second valves are received into the fluid manifold,
a handle assembly;
a nozzle attached to the handle assembly, wherein fluid flows out of the first and second fluid chambers and into the nozzle;
a trigger assembly, wherein movement of the trigger assembly opens and closes the first and second valves; and
wherein the handle assembly and trigger assembly are connected together around the manifold.

2. The spray applicator of claim 1, wherein the spray applicator is snap-fit together.

3. The spray applicator of claim 1, further comprising:
a static mixer within the nozzle.

4. The spray applicator of claim 1, wherein the first and second valves are needle valves projecting into the manifold.

5. The spray applicator of claim 1, wherein the manifold is snap fit into the handle assembly and into the trigger assembly.

6. The spray applicator of claim 1, wherein the manifold is pressurized by fluid flow therethrough but the handle assembly and trigger assembly are not pressurized by fluid flow therethrough.

7. The spray applicator of claim 1, wherein the manifold is configured to burst in an overpressure situation.

8. The spray applicator of claim 1, further comprising:
a first fluid hose connected to the first valve, and
a second fluid hose connected to the second valve.

9. The spray applicator of claim 1, further compromising:
an accelerometer configured to detect movement of the spray applicator, and
an internal control unit in communication with the accelerometer, wherein the internal control unit is configured to power down the spray applicator after a predetermined passage of time with no detected movement.

10. The spray applicator of claim 9, wherein the internal control unit logs any one of movement data, product temperature data, or pressure data of the spray applicator over time.

11. The spray applicator of claim 10, wherein the data can be downloaded from the internal control unit.

12. The spray applicator of claim 1, further comprising:
a third fluid chamber in the manifold, and
a third valve permitting fluid flow into the third fluid chamber.

13. The spray applicator of claim 1, further comprising:
a first fluid component in the first fluid chamber,
a second fluid component in the second fluid chamber, and
air in the third fluid chamber.

14. The spray applicator of claim 1, further comprising:
a spray tube connected to the nozzle.

15. The spray applicator of claim 14, wherein the spray tube terminates in a fan-shaped outlet.

16. The spray applicator of claim 14, wherein the spray tube terminates in a dual stream outlet.

17. The spray applicator of claim 15, where the dual stream outlet comprises first and second spray outlets positioned a fixed distance apart.

18. The spray applicator of claim 17, wherein the first and second spray outlets each terminate in a fan-shaped outlet.

19. The spray applicator of claim 1, wherein the first and second valves are spool valves.
